(19) United States
(12) Patent Application Publication
(10) Pub. No.: US 2010/0259466 A1
(43) Pub. Date: Oct. 14, 2010

(54) PLASMA DISPLAY PANEL

(76) Inventors: Osamu Inoue, Osaka (JP); Hiroshi Asano, Osaka (JP); Yayoi Okui, Osaka (JP); Kojiro Okuyama, Nara (JP); Seigo Shiraishi, Osaka (JP); Yukihiro Morita, Osaka (JP); Kyohei Yoshino, Osaka (JP); Masanori Miura, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/808,034

(22) PCT Filed: Dec. 25, 2008
(86) PCT No.: PCT/JP2008/003965

§ 371 Date: Jun. 14, 2010

(30) Foreign Application Priority Data
Dec. 26, 2007 (JP) 2007-333769

(51) Int. Cl. G09G 3/28

(52) U.S. Cl. 345/60

(57) ABSTRACT

The present invention aims to improve efficiency of a PDP by providing a material suitable for improving a secondary electron emission coefficient of the PDP. In order to achieve the aim, in a PDP 200, an electron emission layer 20 is formed by dispersing electron emissive particles including a crystalline compound on a protective layer 7 made of MgO. The crystalline compound is, for example, CaSnO₃, SrSnO₃, BaSnO₃, or a solid solution of two or more of them (e.g. (Ca, Sr)SnO₃ and (Sr, Ba)SnO₃).

### TECHNICAL FIELD

The present invention relates to a plasma display panel.

### BACKGROUND ART

Plasma display panels (hereinafter, abbreviated as PDPs) have been in practical use and have rapidly become popular because they can easily be made in large sizes, are capable of high speed display, and are low cost.

A general PDP that is presently in practical use has a structure in which two glass substrates being front and back substrates are disposed so as to oppose each other, electrodes are arranged in a regular manner on each of the front and back substrates, and a dielectric layer made, for example, of a low melting glass is provided so as to cover each of the electrodes on the front and back substrates. On the dielectric layer formed on the back substrate, a phosphor layer is provided. On the other hand, on the dielectric layer formed on the front substrate, a protective layer made of MgO is provided in order to protect the dielectric layer from ion bombardment and improve secondary electron emission. In a space between the two substrates, a gas mainly composed of an inert gas such as Ne and Xe is enclosed.

In such a PDP, discharge occurs when voltage is applied to electrodes, and images are displayed by causing phosphors to emit light by the discharge.

There has been a strong demand for improving luminous efficacy of a PDP. As a method for improving the luminous efficacy, a method of lowering dielectric constant of the dielectric layer and a method of increasing partial pressure of Xe in a discharge gas are known. However, use of such methods gives rise to the problem that firing voltage and sustaining voltage are increased.

As a solution to the problem, it is known that the firing voltage and the sustaining voltage can be reduced by using a material with a high secondary electron emission coefficient as a protective layer, and costs can be lowered by using an element with high efficiency and low voltage resistance.

In Patent Literatures 1 and 2, for example, CaO, SrO and BaO that are alkaline earth metal oxides as with MgO but have a higher secondary electron emission coefficient than MgO, and a solid solution of these compounds are considered to be used instead of MgO.

### CITATION LIST

### Patent Literature

### [Patent Literature 1]

Japanese Patent Application Publication No. S52-63663

### [Patent Literature 2]

Japanese Patent Application Publication No. 2007-95436

### SUMMARY OF INVENTION

### Technical Problem

However, CaO, SrO, BaO and the like are less chemically stable than MgO, and readily react with moisture and carbon dioxide in the air to produce hydroxide and carbonate, respectively. If such compounds are produced in a PDP, the PDP cannot be in practical use because the firing voltage and the sustaining voltage cannot be reduced as intended due to reduction of a secondary electron emission coefficient, or an aging time required to reduce voltage is greatly increased.

When a small number of PDPs are produced on a laboratory scale, such degradation due to chemical reaction of CaO, SrO and BaO is avoidable by, for example, controlling atmospheric gases during operation. However, it is difficult to control atmosphere during the whole process in a manufacturing plant. If such control were possible, it would cost too much.

Another problem is that, when a material other than MgO is used as a protective layer, the life of a PDP is reduced because the protective layer shows low resistance against ion bombardment and thus a rate of sputtering caused by gases that are generated when the PDP is driven becomes high.

For these reasons, although the use of a material with a high secondary electron emission coefficient has been considered, only MgO is in practical use as a material for the protective layer.

The present invention is conceived in view of the above problems, and aims to improve efficiency of a PDP by providing a material suitable for improving a secondary electron emission coefficient of the PDP.

### Solution to Problem

The present invention provides a plasma display panel that causes discharge in a discharge space by applying voltage between electrodes and causes phosphors to emit visible light by the discharge, wherein an electron emissive material including a compound is disposed so as to face the discharge space, the compound including (i) one or more selected from Ca (calcium), Sr (strontium), and Ba (barium), (ii) Sn (tin), and (iii) O (oxygen) as main components.

Here, the electron emissive material is disposed in a region to which charged particles are irradiated by the discharge in the discharge space. Specifically, the electron emissive material is disposed on a surface of a protective layer, a surface of a phosphor layer, and a surface of a barrier rib, and also inside the protective layer, the phosphor layer, and the barrier rib.

In particular, it is desirable that a ratio of a dispersed compound to an MgO protective layer be 1% to 20%.

Here, the ratio indicates a ratio of particles of the above-mentioned compound to the protective layer when particles of the compound are projected to a surface of the protective layer.

Furthermore, the above-mentioned main components indicate main elements that constitute the compound. A small amount of elements other than the main components may be included in the compound. In particular, in the compound pertaining to the present invention, the elements other than the main components can be included in place of elements constituting the main components. They are acceptable when an amount thereof is smaller than an amount of the elements constituting the main components.

As the above-mentioned compound, a crystalline oxide that includes (i) one or more selected from Ca, Sr, and Ba and (ii) Sn in a specific ratio is desirable. Specifically, the following is desirable.

CaSnO₃, SrSnO₃, BaSnO₃, or a solid solution of two or more of them.

Sr₃Sn₂O₇, Ba₃Sn₂O₇, or a solid solution of them.

Ca₂SnO₄, Sr₂SnO₄, Ba₂SnO₄, or a solid solution of two or more of them.

### ADVANTAGEOUS EFFECTS OF INVENTION

Although the details are provided in embodiments, a compound that includes one or more selected from Ca, Sr and Ba, and Sn and O (oxygen) as its main components is chemically stable, and has a high secondary electron emission coefficient. Therefore, by disposing the compound so as to face the discharge space in a PDP, drive voltage for the PDP can be reduced and the PDP can be in practical use.

Also, by using a conventional MgO film showing high resistance against ion bombardment as a protective layer and using the above-mentioned compound as an electron emissive material, a PDP that can be driven at low voltage and has a long life can be provided.

### BRIEF DESCRIPTION OF DRAWINGS

FIG. 1 is a perspective view of a PDP in embodiments of the present invention.

FIG. 2 is a longitudinal sectional view of the PDP shown in FIG. 1.

FIG. 3 is a perspective view of a PDP in embodiments of the present invention.

FIG. 4 is a longitudinal sectional view of the PDP shown in FIG. 3.

FIG. 5 shows an example of valence band spectra measured by using an XPS.

FIG. 6 shows an example of C1s spectra measured by using the XPS.

### DESCRIPTION OF EMBODIMENTS

First, an electron emissive material used in a PDP pertaining to the present invention is explained below.

The inventors synthesized a great variety of compounds by reacting CaO, SrO and BaO that have high secondary electron emission efficiency but are chemically unstable with a variety of oxides of metals such as B, Al, Si, P, Ga, Ge, Sn, Ti, Zr, V, Nb, Ta, Mo and W, and examined chemical stability and ability to emit secondary electrons of the compounds in detail. After the examination, the investors found that the chemical stability can be improved without significantly reducing secondary electron emission efficiency by reacting SnO₂ to obtain a compound that includes one or more of Ca, Sr and Ba, and Sn and O. Also, the investors found that, when the obtained electron emissive material is used in a PDP, drive voltage for the PDP can be reduced compared with that for a PDP in which only MgO is used.

(Composition of Electron Emissive Material)

An electron emissive material used in a PDP of the present invention is a compound including one or more of Ca, Sr and Ba, and Sn and O as its main components.

Although the compound may be in an amorphous state, it is desirable that the compound be a crystalline compound in order to further improve stability.

Basically, included among preferred crystalline compounds are the following.

(1) CaSnO₃, SrSnO₃, BaSnO₃, or a solid solution of two or more of them [(Ca, Sr)SnO₃, (Sr, Ba)SnO₃ and the like].

(2) Sr₃Sn₂O₇, Ba₃Sn₂O₇, or a solid solution of them [(Sr, Ba)₃Sn₂O₇].

(3) Ca₂SnO₄, Sr₂SnO₄, Ba₂SnO₄, or a solid solution of two or more of them [(Ca, Sr)₂SnO₄ and the like].

When secondary electron emission efficiencies of these crystalline compounds are compared, compounds including SrO in composition have higher secondary electron emission efficiencies than compounds including CaO, and compounds including BaO have higher secondary electron emission efficiencies than the compounds including SrO.

Also, when a compound including BaO is taken as an example, a compound including more BaO in composition is considered to have higher secondary electron emission efficiency. For example, Ba₃Sn₂O₇ has higher secondary electron emission efficiency than BaSnO₃, and Ba₂SnO₄ has higher secondary electron emission efficiency than Ba₃Sn₂O₇.

On the other hand, chemical stability of these compounds is shown in reverse order.

Since a required chemical stability varies depending on process conditions in actual production of a PDP, it is difficult to determine which compound is the best. However, in these compounds, CaSnO₃, SrSnO₃ and BaSnO₃ are the most desirable because they are as stable as MgO or more stable than MgO, can be used without particularly controlling atmosphere, and have higher electron emission efficiency than MgO.

Among these three compounds, from a viewpoint of low voltage, BaSnO₃ and SrSnO₃ are more desirable, whereas CaSnO₃ is slightly less desirable.

However, in a PDP manufacturing process, other compounds can be used if a certain control over atmosphere is possible. In that case, appropriate compounds may be used according to environment.

(Solid Solution)

It is more desirable to use a solid solution of two or more of CaSnO₃, SrSnO₃ and BaSnO₃ than using one of CaSnO₃, SrSnO₃ and BaSnO₃ alone. This is because, although chemical stabilities of them are almost identical, secondary electron emission efficiency of a solid solution is a little higher than average secondary electron emission efficiency among the two or more included in the solid solution.

Note that although CaSnO₃ and SrSnO₃, and SrSnO₃ and BaSnO₃ form complete solid solutions, CaSnO₃ and BaSnO₃ only form a partial solid solution because lattice constants of CaSnO₃ and BaSnO₃ are too different.

(Partial Substitution in Crystalline Compound)

CaSnO₃, SrSnO₃ and BaSnO₃ can be used as electron emissive materials even when a site for alkaline earth in a crystal is partially substituted with La being a trivalent metal, a site for Sn is partially substituted with In and Y being trivalent metals and Nb being a pentavalent metal, and O is partially substituted with F.

At this time, when a site is substituted with a metal having larger number of valence electrons (e.g. when an alkaline earth is partially substituted with La, and Sn is partially substituted with Nb), stability is slightly reduced but secondary electron emission efficiency is improved. Therefore, by such substitution, it becomes possible to finely adjust properties of a solid solution. In particular, substitution of in for Sn advantageously improves secondary electron emission efficiency. Also, it is possible to partially substitute a site for Sn in a crystal with Ce or Zr.

However, even when substitution is performed in such a manner, main components in composition must be an alkaline earth, Sn and O. For example, when a site for Sn is substituted with In, although all sites for Sn can be substituted, a substitution rate is required to be set to less than 50%. It is desired to be 20% or less, or 10% or less.

When CaSnO₃, SrSnO₃, BaSnO₃ or a solid solution of two or more of them is used in a normal manufacturing process in which atmosphere is not controlled, it is desirable that a ratio of the total number of moles of alkaline earths to the number of moles of Sn, namely (Ca+Sr+Ba)/Sn, be set to be 0.995 or less.

However, when sites for an alkaline earth or Sn are partially substituted as described above, it is desirable that the ratio be set to be 0.955 or less with respect to the total number of moles of substituted elements.

This is because a secondary electron emission coefficient tends to be reduced when the ratio exceeds 0.995. The reason is as follows. Even when the ratio is 1.000, a compound including large amount of an alkaline earth such as Ba₃Sn₂O₇ phase can be formed in a reaction process of an alkaline earth oxide material and SnO₂ due to compositional heterogeneity. Once the compound including large amount of an alkaline earth is formed, such phase covers particle surfaces. Furthermore, under conditions in which atmosphere is not controlled, it is considered that the surfaces are destabilized because, for example, BaCO₃ is separated out.

Note that, when the ratio is further lowered, surplus SnO₂ is separated out at a certain ratio or lower, and thus a mixture of a crystalline compound and SnO₂ is formed. Even in such a state, the above-mentioned effect of suppressing formation of the compound including large amount of an alkaline earth can be obtained.

(Synthetic Method of Electron Emissive Material)

As a method for synthesizing compounds including one or more of Ca, Sr and Ba, and Sn and O as main components, there are a solid phase method, liquid phase method, and gas phase method.

In the solid phase method, base powders (e.g. metal oxide, and metal carbonate) including each metal are mixed, and reacted by heat treatment at a certain temperature or higher.

In the liquid phase method, a solid phase is precipitated in a solution including each metal, or the solution is applied to a substrate, dried, heat-treated at a certain temperature or higher and the like to form a solid phase.

The gas phase method is, for example, deposition, sputtering, and CVD. A membranous solid phase can be obtained in this method.

By the gas phase method, besides the above-mentioned crystalline compound including Ca, Sr, Ba, and Sn in a specific ratio, a compound in an amorphous state that includes one or more of Ca, Sr and Ba, and Sn and O (oxygen) as main components can also be obtained.

Since this film in the amorphous state is more chemically stable than CaO, SrO and BaO, and has higher secondary electron emission efficiency than MgO, drive voltage for a PDP can be reduced. However, since chemical stability of this film is lower than that of a crystalline compound, and, as a synthetic method, the gas phase method is more costly than the solid phase method and the like, a crystalline compound is more desirable.

(Position and Form to Dispose Electron Emissive Material)

Regarding on which part of a PDP panel the above-mentioned electron emissive material should be disposed, generally, it may be disposed on a dielectric layer that covers electrodes formed on a front plate. However, it may be disposed on another part such as phosphors and a surface of a rib, or may be mixed into the phosphors. In this case, an effect of reducing drive voltage can be obtained compared with a case where the electron emissive material is not disposed, as long as it is disposed on a part facing a discharge space.

Regarding a form to dispose the electron emissive material, for example, when the electron emissive material is disposed on a dielectric layer that covers electrodes formed on a front plate, it is considered that a film made of these compounds is disposed, or powders of these compounds are dispersed, on the dielectric layer instead of an MgO film that is usually disposed as a protective layer. Alternatively, after the MgO film is formed, the film made of these compounds may be disposed, or the powders of these compounds may be dispersed, on the MgO film.

When a protective film is made of these compounds, although these compounds have high melting point and are stable, sputtering resistance and transparency of these compounds are lower than those of MgO. When powders of these compounds are dispersed, degradation of brightness due to low transparency can be a further problem. For these reasons, it is desired that an MgO film be used as a protective layer as before, and the powders be dispersed on the MgO film at a level not causing the transparency problem.

As for the level not causing the transparency problem, coverage is preferable to be 20% or less, or is desirable to be 10% or less. When these compounds are used as powders, particle sizes thereof may be selected for, for example, cell sizes from within a range from approximately 0.1 μm to 10 μm. However, when the powders are dispersed, the particle sizes thereof may be 3 μm or less, or desirably 1 μm or less in order not to cause movement or a fall of the powders on the MgO film.

With such structure, an MgO film having a high melting point serves as a protective layer as before, the compound of the present invention plays a role in secondary electron emission. Consequently, a PDP panel that operates at low voltage and has a long life without degradation of brightness because of its low coverage can be obtained.

(Notation of Compound)

In the Specification, a crystalline compound is described, for example, as BaSnO₃. However, Sn is an element that tends to partly be Sn²⁺ in addition to Sn⁴⁺. An oxygen defect occurs in this case. Therefore, more accurately, the crystalline compound should be described as BaSnO₃₋δ. However, since δ here changes depending on manufacturing conditions and the like, and is not necessarily a constant value, it is described as BaSnO₃ for the sake of convenience. For this reason, such notation does not deny an existence of the oxygen defect. The same is applied to compounds other than BaSnO₃.

Besides, a site for Sn can be partially substituted with Ti and Zr being quadrivalent metals similarly to Sn, In being a trivalent metal, Nb being a pentavalent metal and the like. Ca, Sr and Ba can be partially substituted with Mg being a bivalent metal similarly to Ca, Sr and Ba, La a being trivalent metal, K being a monovalent metal and the like. As long as a resulting compound includes one or more of Ca, Sr and Ba, and Sn and O as its main components, and the substitution does not essentially degrade properties (chemically stable and with high secondary electron emission efficiency) of the compound of the present invention, such minor substitution is possible.

(Structure of PDP)

The following describes a specific example of a PDP to which the above-mentioned electron emissive material is applied, with use of drawings.

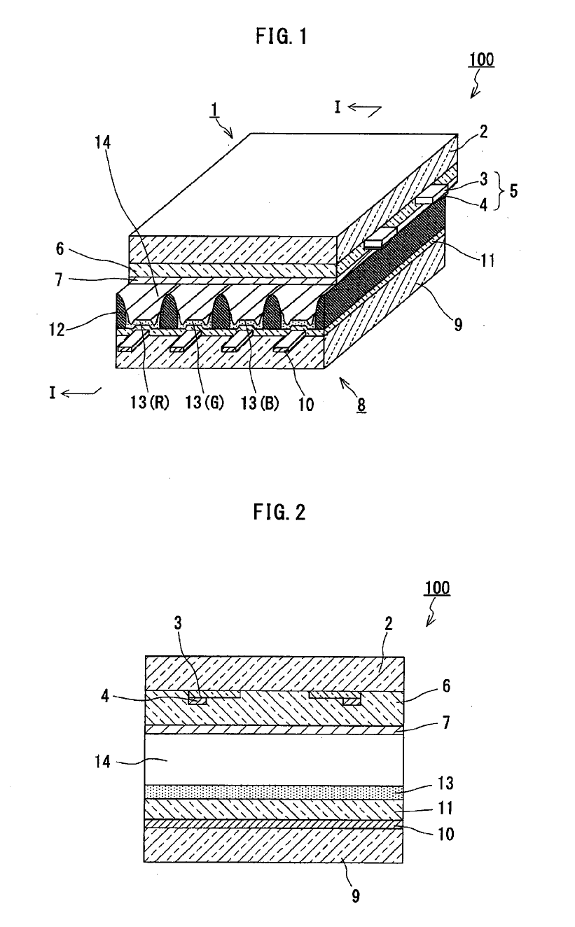

FIGS. 1 and 2 show an example of a PDP 100 pertaining to an embodiment of the present invention. FIG. 1 is an exploded perspective view of the PDP 100, and FIG. 2 is a longitudinal sectional view (a sectional view taken along a line I-I of FIG. 1) of the PDP 100.

As shown in FIGS. 1 and 2, the PDP 100 includes a front plate 1 and a back plate 8. A discharge space 14 is formed between the front plate 1 and the back plate 8. The PDP is a surface discharge AC-PDP, and has a structure similar to a structure of the exemplified conventional PDP except that the above-mentioned electron emissive material is provided as a protective layer.

The front plate 1 includes a front glass substrate 2; display electrodes 5 each composed of a transparent conductive film 3 that is provided on an inner surface (on a surface facing the discharge space) of the front glass substrate 2 and a bus electrode 4; a dielectric layer 6 that is provided so as to cover the display electrodes 5; and a protective layer 7 that is provided on the dielectric layer 6. Each of the display electrodes 5 is provided such that the bus electrode 4 made of Ag and the like for ensuring good conductivity is laminated to the transparent conductive film 3 made of ITO or tin oxide.

The back plate 8 includes a back glass substrate 9; address electrodes 10 that are provided on one surface of the back glass substrate 9; a dielectric layer 11 that is provided so as to cover the address electrodes 10; barrier ribs 12 that are provided on an upper surface of the dielectric layer 11; and a phosphor layer 13 of each color that is provided between the barrier ribs 12. Regarding the phosphor layer 13 of each color, a red phosphor layer 13 (R), a green phosphor layer 13 (G) and a blue phosphor layer 13 (B) are arranged in that order.

As phosphors that constitute the phosphor layer 13, for example, BaMgAl₁₀O₁₇:Eu can be used as blue phosphors, Zn₂SiO₄:Mn can be used as green phosphors and Y₂O₃:Eu can be used as red phosphors.

The front plate 1 and the back plate 8 are joined using a sealing member (not illustrated) such that longitudinal directions of the display electrodes 5 are orthogonal to longitudinal directions of the address electrodes 10, and the display electrodes 5 and the address electrodes 10 face each other.

A discharge gas that is composed of a rare gas component such as He, Xe and Ne is enclosed in the discharge space 14.

Each of the display electrodes 5 and the address electrodes 10 is connected to an external drive circuit (not illustrated). Discharge occurs in the discharge space 14 by applying voltage from the drive circuit, and the phosphor layer 13 is excited to emit visible light by short wavelength ultraviolet light (147 nm wavelength) that is generated along with the discharge.

In the PDP 100 having such structure, since a protective layer 7 is formed with use of the electron emissive material as described above and thus the electron emissive material faces the discharge space 14, an effect of reducing drive voltage can be produced.

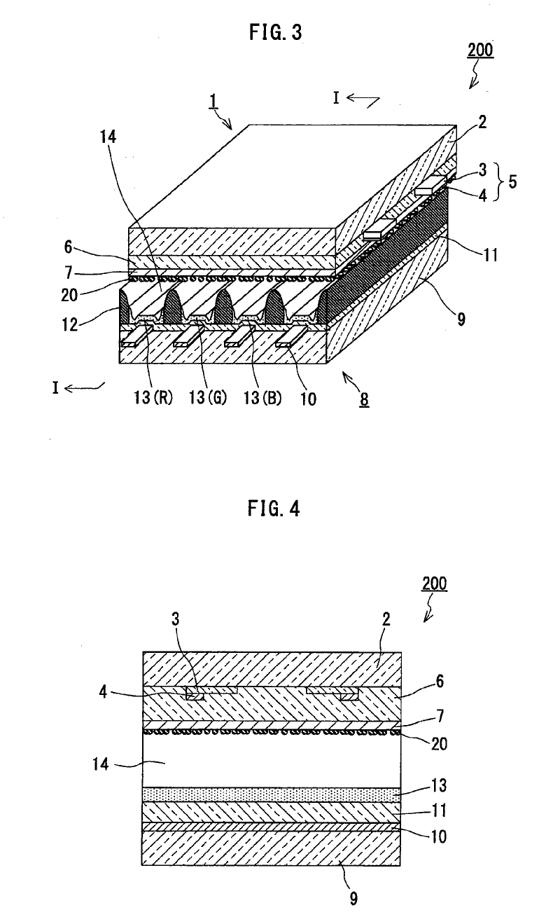

FIGS. 3 and 4 show a PDP 200 pertaining to another embodiment.

FIG. 3 is an exploded perspective view of the PDP 200, and FIG. 4 is a longitudinal sectional view (a sectional view taken along a line I-I of FIG. 3) of the PDP 200.

The PDP 200 has a structure similar to the PDP 100 except that the protective layer 7 is made of MgO, and an electron emission layer 20 is formed such that particles made of the above-mentioned electron emissive material are dispersed on the protective layer 7.

In the PDP 200 having such structure, since the electron emission layer 20 faces the discharge space 14, the effect of reducing drive voltage can be produced.

Note that a PDP in which an electron emissive material is provided is not limited to a surface discharge PDP, and may be an opposing discharge PDP. Furthermore, it is not necessarily a PDP that includes a front plate, a back plate and barrier ribs. It only needs to be a PDP in which discharge is caused in a discharge space by applying voltage between electrodes, and phosphors emit visible light along with the discharge to cause the PDP to emit light. For example, in a PDP that includes a plurality of discharge tubes in which phosphors are provided and emits light by causing discharge inside of each of the discharge tubes, drive voltage can be reduced by providing an electric emission material inside each of the discharge tubes.

(Manufacturing Method of PDP)

As a manufacturing method of a PDP, here, a method for manufacturing a PDP by using an MgO film as the protective layer 7, and dispersing powders of an electron emissive material on the protective layer 7 as with the above-mentioned PDP 200 is described first.

First, a front plate is produced.

In this step, a plurality of linear transparent electrodes are formed on one major side of the flat front glass substrate 2. Then, after silver pastes are applied on the transparent electrodes, the entire front glass substrate 2 is heated to bake the silver pastes, and thus the display electrodes 5 are formed.

A glass paste that includes glass for the dielectric layer 6 is applied to the major side of the front glass substrate 2 by a blade coater method so as to cover the display electrodes 5. Then, the entire front glass substrate 2 is held at 90 degrees Celcius for 30 minutes to dry out the glass paste, and subsequently baked at about 580 degrees Celcius for 10 minutes.

A magnesium oxide (MgO) film is formed on the dielectric layer 6 by an electron beam deposition method, and baked to form the protective layer 7. The baking temperature at the time is approximately 500 degrees Celcius.

After a paste of a mixture of a vehicle such as ethyl cellulose and a powdery electron emissive material is prepared, the paste is applied on the protective layer 7 by a printing method and the like, dried out, and baked at about 500 degrees Celcius to form the electron emission layer 20.

Next, a back plate is produced.

In this step, after a plurality of linear silver pastes are applied on one major side of the flat back glass substrate 9, the entire back glass substrate 9 is heated to bake the silver pastes, and thus the address electrodes 10 are formed.

After glass pastes are applied to between adjacent address electrodes 10, the entire back glass substrate 9 is heated to bake the glass pastes, and thus barrier ribs 12 are formed.

After phosphor inks of colors of R, G and B are applied to between adjacent barrier ribs 12 and the back glass substrate 9 is heated at about 500 degrees Celcius to bake the phosphor inks, the phosphor layer 13 is formed by eliminating resin components (binder) and the like in the phosphor inks.

Then, the front and back plates thus obtained are sealed together with use of sealing glass. The temperature at the time is approximately 500 degrees Celcius.

Thereafter, the inside of the sealed plates is evacuated to a high vacuum and then filled with a rare gas. The PDP is produced in the above-mentioned manner.

On the other hand, as in the case of the above-mentioned PDP 100, the protective layer 7 made of an electron emissive material can be formed on the dielectric layer 6 by appropriately using a normal thin film process such as the electron beam deposition method similarly to a method for forming a protective layer made of MgO.

Alternatively, a thin or thick film made of an electron emissive material can be formed by mixing powders of the electron emissive material with a vehicle, a solvent and the like to form a paste with relatively high powder content, spreading the paste on the dielectric layer 6 by a method such as the printing method, and baking.

As a method for forming the protective layer 7 by dispersing powders of an electron emissive material on the dielectric layer 6, there are a method of preparing a paste with relatively low powder content and using the printing method, a method of dissolving powders in a solvent and dispersing the solvent, a method of using a spin coater and the like.

Note that the above-mentioned structure and manufacturing method of a PDP are just examples, and the present invention is not limited to these.

### EMBODIMENTS

The following describes the present invention in more detail based on embodiments.

### First Embodiment

In this embodiment, an experiment was conducted to confirm an effect of improving chemical stability by reacting CaO, SrO and BaO with SnO₂ by a solid phase powder method and synthesizing electron emissive materials (crystalline compounds).

(Synthesis of Crystalline Compound)

Guaranteed reagent or purer CaCO₃, SrCO₃, BaCO₃ and SnO₂ were used as starting materials. After these materials are weighed so that a mole ratio of each metal ion shows each of No. 4 to 11 in Table 1, the weighed materials were wet blended with use of a ball mill, and dried out to obtain a mixed powder.

The obtained mixed powder was placed into a platinum crucible, and baked in the air at 1200 degrees Celcius to 1500 degrees Celcius for two hours in an electric furnace. After an average particle size of the baked mixed powder was measured, particles having particle sizes larger than the measured average particle size were wet milled using ethanol as a solvent. In this manner, the average particle size was set to be approximately 3 μm in all compositions.

A formation phase was identified by analyzing a part of the milled powder using an X-ray diffractometry.

(Measurement of Weight Increasing Rate)

Next, after a part of the milled powder was weighed, the weighed powder was filled into a non-hygroscopic porous cell. Then, the cell was placed in a constant temperature and moisture chamber with a temperature of 35 degrees Celcius and 60% humidity for twelve hours. After that, the part of the milled powder was weighed again to measure a weight increasing rate. Then, the cell was further placed in a constant temperature and moisture chamber with a temperature of 65 degrees Celcius and 80% humidity for twelve hours. After that, the part of the milled powder was weighed again to measure a weight increasing rate (an integrated value).

Here, the lower the weight increasing rate, the more chemically stable a compound is.

For some samples, measurement by the X-ray diffractometry was performed after the treatment in the constant temperature and moisture chamber.

Also, for comparison, weight increasing rates of an MgO powder as a sample No. 0 and SnO₂ powder as a sample No. 12 were measured in a similar manner. Furthermore, compounds No. 13 to 21 were synthesized by reacting Al₂O₃, SiO₂, GeO₂, TiO₂, ZrO₂, CeO₂ and V₂O₅ as metal oxides other than SnO₂ with SrCO₃ and BaCO₃ in a similar manner to the embodiment. For these compounds, an evaluation was made in a similar manner.

Note that, although the inventors examined much more kinds of compositions as comparative examples than those listed below, a part of the compositions, in particular compositions that have relatively high stabilities and were targeted for X-ray Photo electron Spectroscopy (XPS) measurement and panelization (both described later) is shown.

TABLE 1

| | Composition ratio (mol %) | | | | | Formation | Weight increasing rate (Wt %) | | Embodiment example |
|---|---|---|---|---|---|---|---|---|---|
| No. | Ca | Sr | Ba | Sn | Others | phase | 35° C. 60% 12 h | +65° C. 80% 12 h | Comparative example |
| 0 | | | | | Mg = 100 | MgO | 0.0 | 0.8 | Comparative example |
| 1 | 100 | | | | | CaO | 36.5 | — | Comparative example |
| 2 | | 100 | | | | SrO + Sr(OH)₂ | 34.3 | — | Comparative example |
| 3 | | | 100 | | | Ba(OH)₂ + BaCO₃ | — | — | Comparative example |
| 4 | 50 | | | 50 | | CaSnO₃ | 0.0 | 0.0 | Embodiment example |
| 5 | 66 | | | 33 | | Ca₂SnO₄ | 0.1 | 3.4 | Embodiment example |
| 6 | | 50 | | 50 | | SrSnO₃ | 0.0 | 0.0 | Embodiment example |
| 7 | | 60 | | 40 | | Sr₃Sn₂O₇ | 0.3 | 7.8 | Embodiment example |
| 8 | | 66 | | 33 | | Sr₂SnO₄ | 1.5 | 12.7 | Embodiment example |
| 9 | | | 50 | 50 | | BaSnO₃ | 0.1 | 0.2 | Embodiment example |
| 10 | | | 60 | 40 | | Ba₃Sn₂O₇ | 5.6 | 19.0 | Embodiment example |
| 11 | | | 66 | 33 | | Ba₂SnO₄ | 15.3 | 24.1 | Embodiment example |
| 12 | | | | 100 | | SnO₂ | 0.0 | 0.0 | Comparative example |
| 13 | 33 | | | | Al = 66 | CaAl₂O₄ | 0.2 | 3.6 | Comparative example |
| 14 | | 50 | | | Si = 50 | SrSiO₃ | 1.0 | 4.7 | Comparative example |
| 15 | | 50 | | | Ge = 50 | SrGeO₃ | 0.4 | 4.2 | Comparative example |
| 16 | | 50 | | | Ti = 50 | SrTiO₃ | 0.0 | 0.0 | Comparative example |
| 17 | | 50 | | | Zr = 50 | SrZrO₃ | 0.0 | 0.0 | Comparative example |
| 18 | | 50 | | | Ce = 50 | SrCeO₃ | 0.5 | 2.8 | Comparative example |
| 19 | | | 50 | | Zr = 50 | BaZrO₃ | 1.0 | 1.2 | Comparative example |
| 20 | | | 50 | | Ce = 50 | BaCeO₃ | 0.2 | 2.0 | Comparative example |
| 21 | | 60 | | | V = 40 | Sr₃V₂O₈ | 0.1 | 0.8 | Comparative example |

(Discussion on Examination Results)

In Table 1, in analyses by the X-ray diffractometry of formation phases in No. 1 to 3 not having been reacted with SnO₂, formation of CaO was observed in No. 1. However, presence of mixed Sr(OH)₂ in SrO was observed in No. 2, and BaO itself was not observed and a mixture of Ba(OH)₂ and BaCO₃ was observed in No. 3. This is because SrO is less chemically stable than CaO, and furthermore BaO is less chemically stable than SrO. Therefore, it is considered that SrO and BaO reacted with moisture and carbon dioxide in the air during cooling after baking and consequently hydroxide and carbonate were produced.

Since BaO was not observed in No. 3 and thus it was obvious that No. 3 is the least stable, measurement of the weight increasing rate for No. 3 after the treatment in a constant temperature and moisture chamber was not performed.

On the other hand, formation of intended crystalline compounds was observed in No. 4 to 11 and 13 to 21.

Next, in measurement of a weight increasing rate after the treatment in the constant temperature and moisture chamber with a temperature of 35 degrees Celcius and 60% humidity for twelve hours, weight increasing rates of CaO and SrO in No. 1 and No. 2 pertaining to comparative examples were very high. Furthermore, in an X-ray diffraction of these samples after the treatment, a diffraction peak of an oxide disappeared, and formation of hydroxide and carbonate was observed. Therefore, since it was obvious that CaO and SrO are less chemically stable after BaO in No. 3, an additional treatment under the condition of 65 degrees Celcius and 80% humidity for twelve hours was not performed.

By contrast, weight increasing rates in No. 4 to 11 pertaining to embodiment examples were lower than those in No. 2 and 3. An effect of stabilizing compounds could be confirmed. In particular, CaSnO₃, SrSnO₃ and BaSnO₃ in No. 4, 6 and 9 showed little increase in weight under the condition of 65 degrees Celcius and 80% humidity for twelve hours. Furthermore, in the X-ray diffraction after the treatment, only diffraction peaks of CaSnO₃, SrSnO₃ and BaSnO₃ were observed, and stability that is equivalent to or higher than that of MgO in No. 12 as a comparative example was confirmed.

When (i) No. 13 to 21 in which, as metal oxides other than SnO₂ in comparative examples, Si, Ge, Ti, Zr and Ce being quadrivalent metal oxides similarly to SnO₂, Al being a trivalent metal, and V being a pentavalent metal were reacted to form compounds, are compared with (ii) No. 4, 6 and 9 that each include relatively the same amounts of alkaline earth metal oxide in embodiment examples, it can be seen that the weight increasing rates in No. 4, 6 and 9 pertaining to embodiment examples are lower than those in No. 13 to 21. This indicates that the effect of stabilizing compounds becomes higher when materials are reacted with Sn than with Al, Si, Ge and the like.

Note that the weight increasing rates in No. 13 to 21 pertaining to comparative examples were significantly lower than those in No 1 and 2. In particular, the weight increasing rates in 16 and 17 were equivalent to those in No. 4, 6 and 9 pertaining to embodiment examples. Therefore, it was found that a stabilizing effect can be obtained when materials are reacted with Al, Si, Ge and Ce. In particular, a stabilizing effect that is equivalent to that obtained in embodiment examples can be obtained when materials are reacted with Ti and Zr.

However, in addition to the stabilizing effect, it is important for crystalline compounds to have a favorable secondary electron emission coefficient. The following describes the result of the XPS measurement as a measure of the favorable secondary electron emission coefficient.

(XPS)

In a PDP, it is not easy to directly measure a secondary electron emission coefficient of powdery materials. By observing a decrease in discharge voltage in a PDP, the secondary electron emission coefficient can be indirectly measured. However, it is not easy to produce PDPs for all materials.

After a detailed examination, the inventors found that materials capable of lowering discharge voltage in a PDP can be selected to some extent by measuring and comparing an energy position of a valence band edge and carbon content attributable to carbonate. The XPS is for measuring a spectrum of an electron that is emitted by X-irradiating a sample surface. In general, an analyzing depth thereof is considered to range from some atomic layers to more than a dozen atomic layers, and information about a sample surface that is relatively close to secondary electron emission in a PDP can be obtained.

It is generally considered that the smaller a sum of a band gap width and electron affinity is, the higher a secondary electron emission coefficient is. The secondary electron emission coefficient becomes high when an energy position of a valence band edge is on a low energy side because a band gap width becomes small at the time.

On the other hand, in compounds that include alkaline earth metals, by measuring carbon content attributable to carbonate on a sample surface, a measure of chemical stability can be obtained with higher sensitivity than the weight increasing rate shown in the above Table 1.

That is to say, when a sample is chemically unstable, the sample reacts with carbon dioxide in the air and thus carbon content on a sample surface is increased. When the carbon content reaches or exceeds a certain amount, particle surfaces are completely covered by alkaline earth carbonate such as BaCO₃ having a low secondary electron emission coefficient. In this case, even when the energy position of a valence band edge is on a low energy side, a high secondary electron emission coefficient cannot be obtained.

Therefore, the inventors found that materials capable of lowering discharge voltage in a PDP can be selected to some extent by measuring and comparing an energy position of a valence band edge and carbon content attributable to carbonate, and selecting a material whose energy position of a valence band edge is on a low energy side and has a low carbon content.

The following describes specific examples.

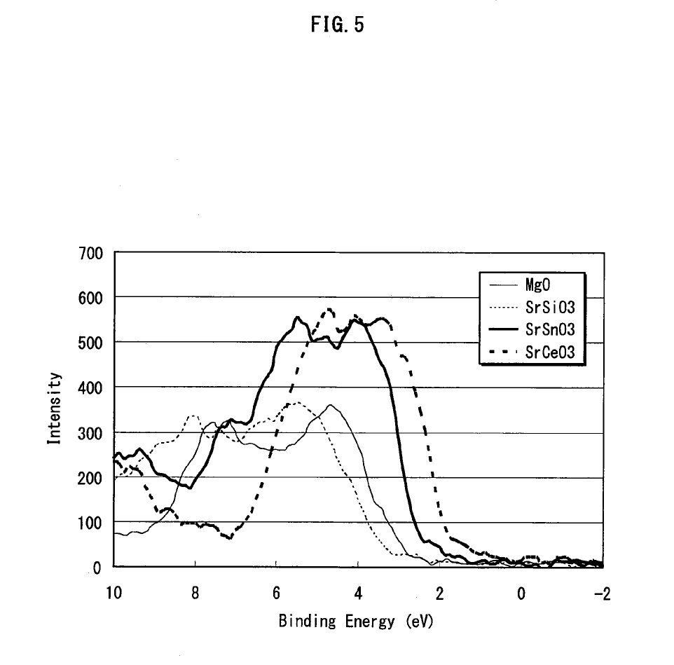

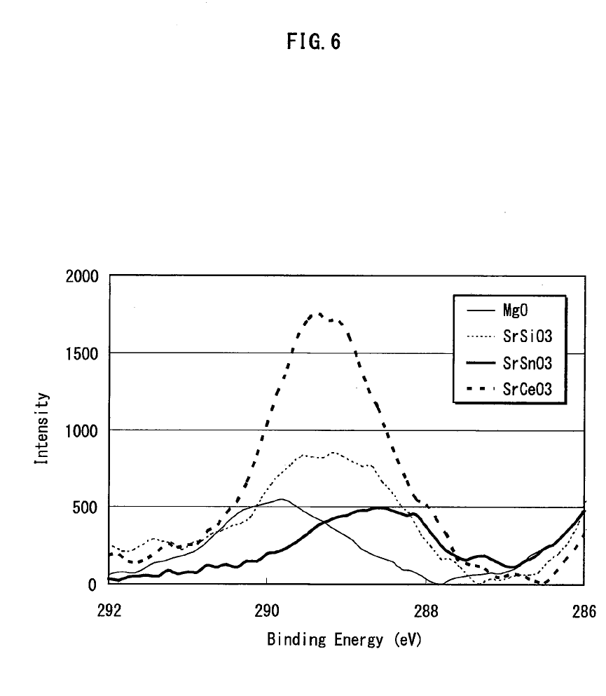

FIG. 5 shows XPS spectra of valence band edges in No. 0, 6, 14 and 18 (i.e. MgO, SrSnO₃, SrSiO₃ and SrCeO₃) in Table 1. FIG. 6 shows XPS spectra of C1s orbital. In FIGS. 5 and 6, background noises are eliminated.

In FIG. 5, when a right margin of a peak is on a right side (i.e. when a value of Binding Energy is low), an energy position of a valence band edge is on a low energy side.

As can be seen in FIG. 5, a valence band edge position of SrSiO₃ is on a higher energy side, and valence band edge positions of SrSnO₃ and SrCeO₃ are on a lower energy side compared with a valence band edge position of MgO.

In FIG. 6, the higher a peak in a range from 288 to 290 eV is, the higher carbon content on a surface is. This is because a peak of carbon content attributable to carbonate appears in the vicinity of the range.

In FIG. 6, carbon content on surfaces of SrSiO₃ and SrCeO₃ is higher because peaks thereof are higher, and carbon content on a surface of SrSnO₃ is lower because a peak thereof is slightly lower compared with a peak of MgO.

From these results, it is unlikely that secondary electron emission efficiency of SrSiO₃ is improved because a valence band edge position of SrSiO₃ is on a higher energy side compared with MgO, and it is unlikely that secondary electron emission efficiency of SrCeO₃ is improved because carbon content on a surface of SrCeO₃ is higher compared with MgO. By contrast, it is likely that secondary electron emission efficiency of SrSnO₃ is improved because a valence band edge position of SrSnO₃ is on a lower energy side and carbon content on a surface of SrSnO₃ is lower compared with MgO.

In order to semi-quantitatively show a valence band edge position and carbon content, the inventors made the XPS measurement for each compound shown in the above Table 1.

Table 2 shows XPS Intensity at 3 eV and 2 eV and XPS Intensity of C1s peak that appears in the vicinity of the region from 288 to 290 eV and is attributable to carbonate. In Table 2, background noises are eliminated.

Here, when values of Intensity at 3 eV and 2 eV are higher, a valence band edge position is on a lower energy side. Furthermore, the lower a value of C peak is, the more chemically stable a compound is.

TABLE 2
(Discussion Based On XPS Measurement Results)

| | Composition ratio (mol %) | | | | | Formation | XPS Intensity (count) | | | Embodiment example |
|---|---|---|---|---|---|---|---|---|---|---|
| No. | Ca | Sr | Ba | Sn | Others | phase | 3 eV | 2 eV | C peak | Comparative example |
| 0 | — | — | — | — | Mg = 100 | MgO | 51.5 | 0.8 | 550 | Comparative example |
| 1 | 100 | | | | | CaO | 25.1 | 2.5 | 2030 | Comparative example |
| 2 | | 100 | | | | SrO + Sr(OH)₂ | 29.4 | 3.5 | 5980 | Comparative example |
| 3 | | | 100 | | | Ba(OH)₂ + BaCO₃ | 50.6 | 4.9 | 5260 | Comparative example |
| 4 | 50 | | | 50 | | CaSnO₃ | 213 | 26.2 | 350 | Embodiment example |
| 5 | 66 | | | 33 | | Ca₂SnO₄ | 196 | 17.9 | 1090 | Embodiment example |
| 6 | | 50 | | 50 | | SrSnO₃ | 257 | 28.7 | 500 | Embodiment example |
| 7 | | 60 | | 40 | | Sr₃Sn₂O₇ | 257 | 35.2 | 1120 | Embodiment example |
| 8 | | 66 | | 33 | | Sr₂SnO₄ | 154 | 33.3 | 1390 | Embodiment example |
| 9 | | | 50 | 50 | | BaSnO₃ | 411 | 55.4 | 420 | Embodiment example |
| 10 | | | 60 | 40 | | Ba₃Sn₂O₇ | 229 | 42.7 | 1500 | Embodiment example |
| 11 | | | 66 | 33 | | Ba₂SnO₄ | 132 | 39.1 | 1660 | Embodiment example |
| 12 | | | | 100 | | SnO₂ | 79.3 | 12.6 | <100 | Comparative example |
| 13 | 33 | | | | Al = 66 | CaAl₂O₄ | 9.3 | 0.6 | 670 | Comparative example |
| 14 | | 50 | | | Si = 50 | SrSiO₃ | 17.9 | 0.6 | 860 | Comparative example |
| 15 | | 50 | | | Ge = 50 | SrGeO₃ | 47 | 18.6 | 640 | Comparative example |
| 16 | | 50 | | | Ti = 50 | SrTiO₃ | 166 | 7.2 | 490 | Comparative example |
| 17 | | 50 | | | Zr = 50 | SrZrO₃ | 185 | 9.3 | 540 | Comparative example |
| 18 | | 50 | | | Ce = 50 | SrCeO₃ | 465 | 128.3 | 1760 | Comparative example |
| 19 | | | 50 | | Zr = 50 | BaZrO₃ | 195 | 17.8 | 530 | Comparative example |
| 20 | | | 50 | | Ce = 50 | BaCeO₃ | 349 | 88.8 | 1870 | Comparative example |
| 21 | | 60 | | | V = 40 | Sr₃V₂O₈ | 146 | 12.8 | 420 | Comparative example |

As can be seen in Table 2, XPS Intensities at 3 eV and 2 eV of compounds in No. 4 to 11 pertaining to embodiment examples are higher than those of compounds in No. 0 to 3 pertaining to comparative examples and SnO₂ in No. 12. In other words, valence band edge positions of the compounds in No. 4 to 11 are on a lower energy side.

Since samples were produced in the air without performing particular atmosphere control in this measurement, carbon content in No. 5, 7, 8, 10 and 11, which include large amounts of alkaline earths, is higher than that of MgO. However, carbon content in No. 4, 6 and 9, which include 50% or less of alkaline earths, is lower than that of MgO.

On the other hand, in comparative examples No. 13 to 21 in which alkaline earth oxides are reacted with metal oxides other than SnO₂, XPS Intensities at 3 eV and 2 eV in No. 13 to 15 in which Al, Si and Ge are used, respectively, are low. However, XPS Intensities at 3 eV and 2 eV in No. 16 to 21 in which Ti, Zr, Ce and V are used are higher than that of MgO. In particular, XPS Intensities at 3 eV and 2 eV in No. 18 and 20 in which Ce is used are higher than that in an embodiment example using Sn. However, carbon content in No. 18 and 20 in which Ce is used is much higher than that of MgO.

Accordingly, CaSnO₃, SrSnO₃ and BaSnO₃ in No. 4, 6 and 9 pertaining to embodiment examples are selected from among compounds whose carbon contents are lower than that of MgO and whose XPS Intensities at 3 eV and 2 eV are high.

(Manufacturing and Discharge Voltage Measurement of PDP)

PDPs were produced with use of crystalline compounds pertaining to the above mentioned embodiment examples and comparative examples, and discharge voltage of the PDPs was measured.

A flat front glass substrate that has a thickness of approximately 2.8 mm and is made of soda lime glass was prepared. ITO (transparent electrode) materials were applied to a surface of the front glass substrate in a predetermined pattern, and dried out. Next, after a plurality of linear silver pastes that are mixtures of silver powder and an organic vehicle were applied, a plurality of display electrodes were formed by heating the front glass substrate and baking the above-mentioned silver pastes.

Then, a glass paste was applied, by a blade coater method, to a front panel on which the display electrodes were produced and dried out by being held at 90 degrees Celcius for 30 minutes. And, a dielectric layer having a thickness of approximately 30 μm was formed by baking the glass paste at 585 degrees Celcius for 10 minutes.

After magnesium oxide (MgO) was deposited on the dielectric layer by an electron beam deposition method, a protective layer was formed by baking the deposited magnesium oxide at 500 degrees Celcius.

Next, regarding compounds in No. 1 to 6, 9, 12, 13, 17, and 21, about 3 parts by weight of powders of each of these compounds and 100 parts by weight of an ethyl cellulosic vehicle were mixed with each other, and the mixed material was milled by using a three roller mill to form a paste. Then, a thin layer of the paste was applied to the MgO layer by a printing method. After being dried out at 90 degrees Celcius, the thin layer was baked in the air at 500 degrees Celcius. At this time, a rate (coverage) at which the MgO layer after baking is covered with powders was set to be a little less than 20% by adjusting concentration of the paste.

For comparison, a PDP that includes an underlying MgO film on which these powders are not dispersed was produced as No. 0.

On the other hand, a back plate was produced in the following manner.

First, address electrodes that are mainly made of silver were formed in stripes on a back glass substrate made of soda lime glass by screen printing. Then a dielectric layer having a thickness of approximately 8 μm was formed in a manner similar to the manner to form the front plate.

Next, barrier ribs were formed between adjacent address electrodes on the dielectric layer with use of glass pastes. The barrier ribs were formed by repeatedly performing screen printing and baking.

Then, red (R), green (G) and blue (B) phosphor pastes were applied to walls of the barrier ribs and exposed surfaces of the dielectric layer between barrier ribs, dried out and baked to produce phosphor layers.

The produced front plate and back plate were sealed together at 500 degrees Celcius with use of a sealing glass. After the air is evacuated from a discharge space, Xe is enclosed in the discharge space as a discharge gas, thus a PDP was produced.

The produced PDP was connected to a drive circuit to emit light. After the PDP is aged by holding the PDP for 100 hours in a light emitting state, sustaining voltage was measured. Here, the aging is performed for cleaning surfaces of an MgO film and dispersed powders to some extent by sputtering. The aging is commonly performed in a manufacturing process of a PDP. When the aging is not performed, discharge voltage of a panel becomes high whether powders are dispersed or not.

The following Table 3 shows discharge voltage measured after the aging.

TABLE 3
(Discussion Based On Discharge Voltage Measurement Results)

| | Composition ratio (mol %) | | | | | | Discharge voltage | | Embodiment example |
|---|---|---|---|---|---|---|---|---|---|
| No. | Ca | Sr | Ba | Sn | Others | Formation phase | Voltage | Difference from No. 0 | Comparative example |
| 0 | | | | | Mg = 100 | Underlying film | 249 V | — | Comparative example |
| 1 | 100 | | | | | | 257 V | +8 V | Comparative example |
| 2 | | 100 | | | | | 254 V | +5 V | Comparative example |
| 3 | | | 100 | | | | 252 V | +3 V | Comparative example |
| 4 | 50 | | | 50 | | CaSnO₃ | 231 V | −18 V | Embodiment example |
| 5 | 66 | | | 33 | | Ca₂SnO₄ | 234 V | −15 V | Embodiment example |
| 6 | | 50 | | 50 | | SrSnO₃ | 224 V | −25 V | Embodiment example |
| 9 | | | 50 | 50 | | BaSnO₃ | 220 V | −29 V | Embodiment example |
| 12 | | | | 100 | | SnO₂ | >280 V | >+31 V | Comparative example |
| 13 | | | | | | CaAl₂O₄ | 252 V | +3 V | Comparative example |
| 17 | | 50 | | | Zr = 50 | SrZrO₃ | >280 V | >+31 V | Comparative example |
| 20 | | | 50 | | Ce = 50 | BaCeO₂ | 261 V | +12 V | Comparative example |
| 21 | | 60 | | | V = 40 | Sr₃V₂O₈ | >280 V | >+31 V | Comparative example |

Discharge voltage of PDPs in which powders in No. 4, 5, 6 and 9 pertaining to embodiment examples are dispersed were lower than that in No. 0 only using an MgO thin film. In particular, discharge voltage of PDPs in which SrSnO₃ powders and BaSnO₃ powders in No. 6 and 9 were used, respectively, is significantly lower, and thus an effect of reducing drive voltage produced by the present invention could be confirmed.

On the other hand, in PDPs in which powders in No. 1, 2 and 3 pertaining to comparative examples are dispersed, reduction of discharge voltage was not observed compared with that in No. 0 only using an MgO thin film.

In PDPs in which powders of No. 12 pertaining to a comparative example, which includes only SnO₂ and not include alkaline earths, and No. 13, 17, 20 and 21 pertaining to comparative examples, which include alkaline earths but not Sn, are dispersed, although reasons are unclear, the PDPs using powders in No. 12, 17 and 21 stopped emitting light during aging. Furthermore, discharge voltage of PDPs using powders in No. 13 and 20, which emitted light, were not lower than that in No. 0 only using an MgO thin film but rather higher than that in No. 0.

Presumably, the reason why the discharge voltage of a PDP using powders in No. 13 was not decreased is that, as can be seen from the XPS measurement for CaAl₂O₄, a valence band edge position of CaAl₂O₄ is on a high energy side. Presumably, the reason why the discharge voltage of a PDP using powders in No. 20 was not decreased is that carbon content of BaCeO₃ is high.

Regarding SrZrO₃ in No. 17 and Sr₃V₂O₈ in No. 21 pertaining to comparative examples, valence band edge positions are on a higher energy side compared with those in No. 4, 6 and 9. However, since the valence band edge positions are on a lower energy side compared with that of MgO in No. 0 and carbon content in No. 17 and 21 is not so high, it is considered that discharge voltage of PDPs using powders in No. 17 and 21 can be lower than that of a PDP in No. 0. In fact, the discharge voltage of the PDPs using powders in No. 17 and 21 was not decreased as shown in Table 3.

Also, discharge voltage of PDPs using compounds that include transition metals as main components such as BaCeO₃ in No. 20 was not decreased regardless of stability and results of XPS.

The reason why a secondary electron emission coefficient of compounds including transition metals is not increased is unclear. However, the reason is considered to be as follows. A d orbital electron is at a valence band edge or an empty d electron orbit is on a conductive band. Since an orbital of the d electron on the valence band is localized compared with orbitals of an s orbital electron and p orbital electron, it is less likely to transit to the conductive band beyond a band gap. Even when an electron having transited beyond the band gap is trapped by the d electron orbital on the conductive band, the electron is less likely to be emitted into vacuo due to localization of its orbital.

In contrast, Sn included in compounds pertaining to embodiment examples is a representative metal. Since a broader s orbital and p orbital contribute to electron emission, the compounds are considered to easily emit secondary electrons.

### Second Embodiment

In this embodiment, a case where composition rate of elements is changed, a case where solid solution with various metal oxides is formed, and a case where Ba or Sn is substituted with another metal are shown with a focus on BaSnO₃.

In a similar manner to Embodiment 1, by using guaranteed reagent or purer CaCO₃, SrCO₃, BaCO₃, SnO₂ and various metal oxides as starting materials, the inventors weighed these materials so that element ratios show composition ratios (atom ratios) shown in Table 4, and mixed, dried out and baked the weighed materials to synthesize powders of compounds shown in Table 4.

Identification by an X-ray diffraction, evaluation of hygroscopicity, and XPS measurement were performed for the synthesized compounds. Furthermore, similarly to Embodiment 1, PDPs were produced by using apart of these powders, and discharge voltage of these PDPs was measured. At this time, although discharge voltage was measured after PDPs were aged by holding the PDPs for 100 hours in Embodiment 1, discharge voltage was measured after PDPs were aged by holding the PDPs for 25 hours and 100 hours in this embodiment.

The following Table 4 shows the results.

TABLE 4
(Discussion on Ratio of Ba to Sn)

| | | | | | | | XPS | | | | |
|---|---|---|---|---|---|---|---|---|---|---|---|
| | Composition ratio | | | | Hygrosopicity | | Intensity | | | | |
| | (Atom ratio) | | | Formation phase | 35° C. | +65° C. | (count) | | Discharge voltage (v) | | |
| No. | Ba | Sn | Others | (X-ray diffraction) | 60% | 80% | 2 eV | C peak | 24 h | 100 h | E or C |
| 0 | | | Mg = 100 | Underlying MgO film | — | — | — | — | 245 | 249 | C |
| 6 | 0 | 1 | Sr = 1.0 | SrSnO₃ | 0.0 | 0.0 | 28.7 | 500 | 240 | 224 | E |
| 9 | 1 | 1 | | BaSnO₃ | 0.1 | 0.2 | 48.3 | 420 | 236 | 220 | E |
| 31 | 1.005 | 1 | | BaSnO₃ | 0.1 | 0.4 | 44.6 | 430 | — | — | E |
| 32 | 1.01 | 1 | | BaSnO₃ | 0.2 | 1.2 | 35.0 | 460 | 248 | 238 | E |
| 33 | 0.995 | 1 | | BaSnO₃ | 0.0 | 0.0 | 50.9 | 390 | 229 | 220 | E |
| 34 | 0.99 | 1 | | BaSnO₃ + SnO₂ | 0.0 | 0.0 | 53.8 | 350 | 225 | 221 | E |
| 35 | 0.98 | 1 | | BaSnO₃ + SnO₂ | 0.0 | 0.0 | 41.5 | 310 | — | — | E |
| 36 | 0.8 | 1 | Sr = 0.2 | (Ba_{0.8}Sr_{0.2})SnO₃ | 0.1 | 0.1 | 49.7 | 420 | — | — | E |
| 37 | 0.6 | 1 | Sr = 0.4 | (Ba_{0.6}Sr_{0.4})SnO₃ | 0.0 | 0.0 | 60.1 | 450 | 238 | 216 | E |
| 38 | 0.4 | 1 | Sr = 0.6 | (Ba_{0.4}Sr_{0.6})SnO₃ | 0.0 | 0.0 | 52.4 | 470 | — | — | E |
| 39 | 0.2 | 1 | Sr = 0.8 | (Ba_{0.2}Sr_{0.8})SnO₃ | 0.0 | 0.0 | 42.5 | 490 | — | — | E |
| 40 | 0.95 | 1 | Ca = 0.05 | (Ba_{0.95}Ca_{0.05})SnO₃ | 0.0 | 0.0 | 55.5 | 440 | — | — | E |
| 41 | 0.6 | 1 | Sr = 0.39 | (Ba_{0.6}Sr_{0.39})SnO₃ | 0.0 | 0.0 | 62.6 | 410 | 227 | 217 | E |
| 42 | 1 | 0.95 | In = 0.05 | Ba(Sn_{0.95}In_{0.05})Oₓ | 0.1 | 1.5 | 60.5 | 510 | — | — | E |
| 43 | 1 | 0.9 | In = 0.1 | Ba(Sn_{0.9}In_{0.1})Oₓ | 0.1 | 2.0 | 164.4 | 660 | 242 | 212 | E |
| 44 | 1 | 0.8 | In = 0.2 | Ba(Sn_{0.8}In_{0.2})Oₓ | 0.1 | 2.9 | 247.2 | 790 | — | — | E |
| 45 | 1 | 0.5 | In = 0.5 | Ba(Sn_{0.5}In_{0.5})Oₓ | 0.7 | 4.0 | 172.2 | 1240 | — | — | E |
| 46 | 1 | 0 | In = 1.0 | Ba₂In₂O₅ | 1.5 | 18.5 | 63.9 | 1800 | — | — | C |
| 47 | 0.98 | 0.9 | In = 0.1 | Ba_{0.98}(Sn_{0.9}In_{0.1})Oₓ | 0.1 | 0.8 | 155.3 | 440 | 229 | 213 | E |
| 48 | 1 | 0.95 | Y = 0.05 | Ba(Sn_{0.95}Y_{0.05})Oₓ | 0.4 | 1.6 | 80.5 | 580 | — | — | E |
| 49 | 1 | 0.95 | Nb = 0.05 | Ba(Sn_{0.95}Nb_{0.05})Oₓ | 0.0 | 0.0 | 41.8 | 380 | 231 | 229 | E |
| 50 | 0.95 | 1 | La = 0.05 | (Ba_{0.95}La_{0.05})SnOₓ | 0.0 | 0.0 | 44.9 | 400 | — | — | E |

No. 9 and 31 to 35 are crystalline compounds obtained by changing a mole ratio of Ba to Sn in materials to be mixed between 0.98 to 1.01 at the time when BaSnO₃ is synthesized by mixing BaCO₃ and SnO₂. Table 4 shows that the higher the mole ratio of Ba is, the higher hygroscopicity and carbon content (C peak) are.

On the other hand, when PDPs are produced with use of these crystalline compounds, discharge voltage has already decreased not only after 100 hours but also after 24 hours of aging in No. 33 and 34 in which the mole ratio of Ba to Sn is lower than 1.000. However, discharge voltage was not reduced after 24 hours of aging in No. 31 and 32 in which the mole ratio of Ba to Sn is higher than 1.000. Furthermore, discharge voltage was not so decreased after 100 hours of aging in No. 32 in which the mole ratio of Ba to Sn is the highest.

This is considered to be caused by the following reason. When the mole ratio of Ba to Sn in mixing materials is 1.000 or higher, a small amount of compounds (e.g. Ba₃Sn₂O₇) that include more Ba is formed due to compositional heterogeneity. Under conditions in which atmosphere is not controlled, the compounds cover particle surfaces because the compounds readily react with carbon dioxide. Also, since the larger an amount of Ba is, the more the compounds are formed, an aging time required to remove compounds covering particle surfaces by sputtering is increased.

Here, the longer the aging time is, the lower efficiency to produce a panel is. In order to decrease the aging time, it is desired that the mole ratio of Ba to Sn be lower than 1.000, preferably equal to 0.995 or lower.

Note that when the ratio is 0.99 or lower, it is observed by an X-ray diffraction that SnO₂ is separated out. SnO₂ residues that are observed as a result of reaction of Ba materials with Sn materials are evidence that compounds that include Ba more than Sn are not formed. For this reason, it is desirable that a composition in which BaSnO₃ and a little amount of SnO₂ are mixed be formed.

The lower limit of the mole ratio of Ba to Sn is not particularly set. However, as shown in Embodiment 1, since SnO₂ itself does not have an effect of reducing voltage, significantly reducing the ratio merely results in a waste of SnO₂. Accordingly, it is desirable that the ratio be 0.90 or higher, and it is more desirable that the ratio be 0.95 or higher.

Although BaSnO₃ is focused in the above, similar results could be obtained for SrSnO₃, CaSnO₃ and solid solution of them.

(Discussion on Solid Solution)

No. 36 to 41 are solid solutions of BaSnO₃ and SrSnO₃ or a solid solution of BaSnO₃ and CaSnO₂.

Although reasons are unclear, compared with SrSnO₃ in No. 6 and BaSnO₃ in No. 9, Intensities at 2 eV of these solid solutions are higher, and discharge voltage of these solid solutions is slightly lower. However, carbon content measured by XPS of these solid solutions is similar to that of SrSnO₃ in No. 6 and BaSnO₃ in No. 9.

Although a ratio of Sr in No. 41 is set to be slightly lower than that in No. 37 and consequently a total amount of alkaline earths becomes slightly smaller, an effect of reducing carbon content and so on can be obtained.

Although not shown in Table 4, the similar effect could be observed in a solid solution of SrSnO₃ and CaSnO₃. Note that an upper limit of a ratio of CaSnO₃ to BaSnO₃ in a solid solution was approximately 7%.

(Discussion on Substitution of Ba and Sn)

In No. 42 to 50, Ba or Sn in BaSnO₃ is substituted with a metal having a different valence.

In No. 42 to 48 in which Sn in BaSnO₃ in No. 9 is substituted with In or Y, Intensity at 2 eV measured by XPS is high. In No. 43, discharge voltage after 100 hours of aging is slightly decreased. By substituting Sn with a metal element having lower valence in this manner, it can be seen that Intensity at 2 eV measured by XPS is increased. However, as No. 45 and 46, when a substitution rate is too high, carbon content increases significantly.

On the other hand, in No. 49 in which Sn in BaSnO₃ in No. 9 is substituted with Nb, and in No. 50 in which Ba in BaSnO₃ in No. 9 is substituted with La, Intensity at 2 eV measured by XPS is reduced but carbon content is decreased and discharge voltage after 24 hours of aging is reduced. By substituting Sn or Ba with a metal element having higher valence in this manner, carbon content can be decreased and discharge voltage can be reduced.

Although not shown in Table 4, the similar effect could be observed in a case where Sr or Sn in SrSnO₃ is substituted with a metal having a different valence in the similar manner. However, a composition range to form a substitutional solid solution of SrSnO₃ is narrower than that of BaSnO₃. In BaSnO₃, all sites for Sn can be substituted with In. However, In SrSnO₃, an upper limit of a ratio of Sn that is substituted with In was approximately 5 to 10%.

In No. 47, Sn in BaSnO₃ in No. 9 is substituted with In, and a ratio of the number of moles of Ba to the total number of moles of Sn and In is set to be lower than 1.000. Discharge voltage after 24 hours of aging is decreased compared with No. 9. An effect of reducing discharge voltage due to decrease of a ratio of alkaline earths can be observed in substitutional solid solutions.

### Third Embodiment

In this embodiment, although PDPs were produced with use of BaSnO₃ powders in a similar manner to the above Embodiment 1, coverage when the BaSnO₃ powders are dispersed on an MgO layer is changed. Then properties of the produced PDPs were examined.

The BaSnO₃ powders are dispersed on the MgO layer in the following manner.

The BaSnO₃ powders were synthesized by mixing materials such that a ratio of Ba to Sn is 0.995:1 and baking the mixture in the air at 1150 degrees Celcius for two hours.

By using the obtained BaSnO₃ powders having a particle diameter of approximately 1 μm, pastes for printing were produced in a similar manner to Embodiment 1. At the time, five kinds of pastes respectively having concentration (concentration of solids in each paste) of 0.2%, 1%, 2%, 4.3% and 20% were produced.

The BaSnO₃ powders were dispersed on the MgO layer by applying each paste on the MgO layer in a similar manner to Embodiment 1, drying and baking. Coverage of the BaSnO₃ powders to the MgO layer was measured for each paste.

The coverage indicates a ratio of the BaSnO₃ powders when the BaSnO₃ powders are projected on a protective layer. The coverage was measured by calculating a ratio of the BaSnO₃ powders to the protective layer in a surface image of the protective layer on which the BaSnO₃ powders are dispersed.

The five kinds of PDPs having a different coverage of the BaSnO₃ powders to the MgO layer were produced in this manner.

Similarly to Embodiment 2, discharge voltage after 24 hours of aging and after 100 hours of aging of the produced PDPs and a PDP having coverage of 0% in which the BaSnO₃ powders are not dispersed was measured.

Coverage and discharge voltage measurement for each paste concentration results are shown in Table 5.

TABLE 5

| | Paste concentration | Coverage | Discharge voltage (v) | |
|---|---|---|---|---|
| No. | (%) | (%) | After 24 h | After 100 h |
| 0 | 0 | 0 | 245 | 249 |
| 51 | 0.2 | 1.1 | 236 | 235 |
| 52 | 1 | 8.2 | 224 | 222 |
| 53 | 2 | 19.3 | 227 | 221 |
| 54 | 4.3 | 36.5 | 239 | 220 |
| 55 | 20 | 91.3 | 255 | 233 |

As shown in Table 5, naturally, the higher the paste concentration is, the higher the coverage is.

In No. 51 to 54 in which the MgO layer is covered with the BaSnO₃ powders, it was observed that discharge voltage after 24 hours and 100 hours of aging is reduced compared with No. 0 in which the MgO layer is not covered with the BaSnO₃ powders. However, in No. 54 having higher coverage of 36.50, an effect of reducing discharge voltage after 24 hours of aging was decreased. Furthermore, in No. 55 having coverage of nearly 100%, the effect of reducing discharge voltage after 24 hours of aging was not observed, and the effect of reducing discharge voltage after 100 hours of aging was insufficient.

This is because, since the higher the coverage is, the larger the amount of the powders is, a longer time is required to clean particle surfaces and an aging time is increased.

While the coverage closely relates to an in-line transmittance of light, the coverage does not directly relate to a scattering transmittance of light that directly correlates with brightness of a PDP. However, excessively high coverage is unfavorable because the scattering transmittance is reduced as the in-line transmittance is reduced when the coverage is too high. Furthermore, it was observed that variability in brightness among cells becomes more significant when the coverage is higher.

On the other hand, in No. 51 having coverage of 1.1%, although discharge voltage was reduced after 24 hours of aging, the discharge voltage was not significantly reduced. This is because an amount of powders is small.

Consequently, in order to obtain an effect of reducing discharge voltage when a protective layer is covered with crystalline compounds, it is preferable that the coverage be 1.0% or higher. Also, in order to decrease the aging time, it is preferable that the coverage be reduced to be 20% or lower, and it is preferable that the coverage be 10% or lower for practical purposes.

### Fourth Embodiment

In this embodiment, the BaSnO₃ powders are not dispersed on the MgO layer on a front plate but dispersed into a phosphor layer on a back plate.

The BaSnO₃ powders are dispersed into the phosphor layer in the following manner.

In a similar manner to Embodiment 1, the BaSnO₃ powders having a particle size of approximately 2 μm were synthesized by mixing materials such that a ratio of Ba to Sn is 0.99:1 and baking the mixture in the air at 1250 degrees Celcius for two hours.

A phosphor paste was produced by mixing 5% by weight of the obtained powders with phosphor powders. Then PDPs were produced in a similar manner to Embodiment 1 except that the phosphor layer is formed by using the phosphor paste.

When discharge voltage after 24 hours of aging of the produced PDPs was measured in a similar manner to Embodiment 2, the discharge voltage was decreased by 15 V compared with that of a PDP using powders in No. 0.

When the BaSnO₃ powders are mixed into phosphors as in this embodiment, it is preferable that a ratio of mixed BaSnO3 powders to the phosphors be 1% by weight or higher. This is because an effect of reducing discharge voltage could not be observed when the ratio is lower than 1% by weight. On the other hand, when the ratio was increased, brightness was reduced due to decrease of an amount of the phosphors. Accordingly, in order to prevent such reduction in brightness, it is preferable that the ratio be 10% by weight or lower.

### INDUSTRIAL APPLICABILITY

Since the present invention can improve discharge properties and reduce drive voltage for a PDP, the present invention is useful for realizing a PDP that can be driven with low power consumption.

### REFERENCE SIGNS LIST

1 front plate
2 front glass substrate
3 transparent conductive film
4 bus electrode
5 display electrode
6 dielectric layer
7 protective layer
8 back plate
9 back glass substrate
10 address electrode
11 dielectric layer
12 barrier rib
13 phosphor layer
14 discharge space
20 electron emission layer

1.-22. (canceled)

23. A plasma display panel that causes discharge in a discharge space by applying voltage between electrodes and causes phosphors to emit visible light by the discharge, wherein
an electron emissive material including a crystalline oxide is disposed so as to face the discharge space, the crystalline oxide including one or more selected from (i) CaSnO₃, (ii) SrSnO₃, (iii) BaSnO₃, and (iv) a solid solution of two or more selected from CaSnO₃, SrSnO₃, and BaSnO₃, and
a ratio of the total number of Ca atoms, Sr atoms, and Ba atoms to the number of Sn atoms in the crystalline oxide is 0.995 or less.

24. The plasma display panel of claim 23, wherein
the ratio of the total number of Ca atoms, Sr atoms, and Ba atoms to the number of Sn atoms is 0.90 or more.

25. The plasma display panel of claim 23, wherein
the electron emissive material includes a mixture of the crystalline oxide and SnO₂.

26. A plasma display panel that causes discharge in a discharge space by applying voltage between electrodes and causes phosphors to emit visible light by the discharge, wherein
an electron emissive material including a crystalline oxide is disposed so as to face the discharge space, the crystalline oxide including (i) one or more selected from Ca, Sr, and Ba and (ii) Sn in a specific ratio, and
the one or more selected from Ca, Sr, and Ba included in the crystalline oxide are partially substituted with one or more trivalent metal elements.

27. A plasma display panel that causes discharge in a discharge space by applying voltage between electrodes and causes phosphors to emit visible light by the discharge, wherein
an electron emissive material including a crystalline oxide is disposed so as to face the discharge space, the crystalline oxide including (i) one or more selected from Ca, Sr, and Ba and (ii) Sn in a specific ratio, and
Sn included in the crystalline oxide is partially substituted with a trivalent metal element or a pentavalent metal element.

28. The plasma display panel of claim 27, wherein
Sn included in the crystalline oxide is partially substituted with In.

29. A plasma display panel that causes discharge in a discharge space by applying voltage between electrodes and causes phosphors to emit visible light by the discharge, wherein
an electron emissive material including a crystalline oxide is disposed so as to face the discharge space, the crystalline oxide including one or more selected from (i) Sr₃Sn₂O₇, (ii) Ba₃Sn₂O₇, and (iii) a solid solution of Sr₃Sn₂O₇ and Ba₃Sn₂O₇.

30. A plasma display panel that causes discharge in a discharge space by applying voltage between electrodes and causes phosphors to emit visible light by the discharge, wherein
an electron emissive material including a crystalline oxide is disposed so as to face the discharge space, the crystalline oxide including one or more selected from (i) Ca₂SnO₄, (ii) Sr₂SnO₄, (iii) Ba₂SnO₄, and (iv) a solid solution of two or more selected from Ca₂SnO₄, Sr₂SnO₄, and Ba₂SnO₄.

31. A plasma display panel that causes discharge in a discharge space by applying voltage to a first electrode and a second electrode and causes phosphors to emit visible light by the discharge, the plasma display panel comprising:
a first panel that includes (i) a first substrate, (ii) the first electrode positioned on the first substrate, (iii) a first dielectric layer positioned on the first substrate so as to cover the first electrode, and (iv) a protective layer that is positioned on the first dielectric layer and mainly made of MgO; and
a second panel that includes (i) a second substrate, (ii) the second electrode positioned on the second substrate, (iii) a second dielectric layer positioned on the second substrate so as to cover the second electrode, and (iv) a phosphor layer positioned on the second dielectric layer, wherein
the first panel and the second panel oppose each other with the discharge space therebetween, and
an electron emissive material including a crystalline oxide is dispersed, in the form of particles, on the protective layer, the crystalline oxide including one or more selected from (i) CaSnO₃, (ii) SrSnO₃, (iii) BaSnO₃ and (iv) a solid solution of two or more selected from CaSnO₃, SrSnO₃, and BaSnO₃.

32. The plasma display panel of claim 31, wherein
a ratio of the dispersed crystalline oxide to the covered protective layer is 1% to 20%.

33. A plasma display panel that causes discharge in a discharge space by applying voltage to a first electrode and a second electrode and causes phosphors to emit visible light by the discharge, the plasma display panel comprising:
a first panel that includes (i) a first substrate, (ii) the first electrode positioned on the first substrate, (iii) a first dielectric layer positioned on the first substrate so as to cover the first electrode, and (iv) a protective layer that is positioned on the first dielectric layer and mainly made of MgO; and
a second panel that includes (i) a second substrate, (ii) the second electrode positioned on the second substrate, (iii) a second dielectric layer positioned on the second substrate so as to cover the second electrode, and (iv) a phosphor layer positioned on the second dielectric layer, wherein
the first panel and the second panel oppose each other with the discharge space therebetween, and
an electron emissive material including a crystalline oxide is mixed, in the form of particles, into the phosphor layer, the crystalline oxide including one or more selected from (i) CaSnO₃, (ii) SrSnO₃, (iii) BaSnO₃, and (iv) a solid solution of two or more selected from CaSnO₃, SrSnO₃, and BaSnO₃.

34. The plasma display panel of claim 33, wherein
a ratio of the mixed crystalline oxide to the phosphors in the phosphor layer is 1% by weight to 10% by weight.
